(19) United States
(12) Patent Application Publication
(10) Pub. No.: US 2025/0244140 A1
(43) Pub. Date: Jul. 31, 2025

(54) DETERMINING A SET OF INFORMATION TO BE USED TO PRODUCE A MAP OF A REGION

(71) Applicant: Toyota Jidosha Kabushiki Kaisha, Toyota-shi Aichi-ken (JP)

(72) Inventor: Eitan Gilad Mendelowitz, Northampton, MA (US)

(21) Appl. No.: 18/428,175

(22) Filed: Jan. 31, 2024

(51) Int. Cl. G01C 21/00; B60W 60/00

(52) U.S. Cl. CPC G01C 21/3815; B60W 60/001; G01C 21/3841; G01C 21/3885; B60W 2556/40; B60W 2556/45

(57) ABSTRACT

A system for determining a set of information to be used to produce a map of a region can include a processor and a memory. The memory can store a set determination module, a production module, and a communications module. The set determination module can determine, from: (1) positions of a vehicle that traversed a region and (2) data affiliated with images produced by a camera on the vehicle, a set of information to be used to produce a map of the region. An optimal state of the set can be based on one or more of: (1) a characteristic of the information or (2) an aspect, in the region, to be included in the map. The production module can produce, from the set, the map. The communications module can transmit the map to a specific vehicle to control movement of the specific vehicle.

### TECHNICAL FIELD

The disclosed technologies directed to determining a set of information to be used to produce a map of a region.

### BACKGROUND

A digital map can be an electronic representation of a conventional paper road map. For example, an automotive navigation system can use information received from a digital map and information received from a global navigation satellite system (GNSS) to produce a turn-by-turn navigation service. A turn-by-turn navigation service can provide a route between an origination point and a destination point. A position of a vehicle determined by such a turn-by-turn navigation service can be within a meter of an actual position.

More recently, technologies have been developed to automate one or more operations of one or more vehicle systems to control movement of a vehicle. Such technologies can use information received from a digital map to control such movement. However, such a digital map can be required to indicate positions of objects with a degree of accuracy that is within a decimeter. Accordingly, development of technologies to automate control of movement of vehicles have been accompanied by efforts to improve the degree of accuracy of digital maps. This has led to the production of high-definition (HD) maps.

An HD map can be a digital map that includes additional information to improve the degree of accuracy required to automate control of movement of a vehicle. An HD map can be characterized as having layers of additional information. Each layer of additional information can be affiliated with a specific category of additional information. These layers can include, for example, a layer of a base map, a layer of a geometric map, and a layer of a semantic map. The base map, the geometric map, and the semantic map can include information about static aspects of a location.

The geometric map can be produced, for example, using a simultaneous localization and mapping (SLAM) technique. A SLAM technique can use proprioception information to estimate a pose (i.e., a position and an orientation) of a vehicle, and perceptual information to correct an estimate of the pose. Usually, the proprioception information can be one or more of GNSS information, inertial measurement unit (IMU) information, odometry information, or the like. For example, the odometry information can be a value included in a signal sent to a vehicle system (e.g., an accelerator). The perceptual information can often be one or more of point cloud information from a ranging sensor (e.g., a light detection and ranging (lidar) system), image data from one or more images from one or more image sensors or cameras, or the like. The geometric map can include, for example, a ground map of improved surfaces for use by vehicles and pedestrians (e.g., drivable surfaces (e.g., roads)), and voxelized geometric representations of three-dimensional objects at the location.

The semantic map can include semantic information about objects included at the location. The objects can include, for example, landmarks. A landmark can be, for example, a feature that can be easily re-observed and distinguished from other features at the location. The term landmark, in a context of indicating positions of objects with a degree of accuracy that is within a decimeter, can be different from a conventional use of the term landmark. For example, landmarks can include lane boundaries, road boundaries, road junctions (e.g., intersections, interchanges, etc.), crosswalks, bus lanes, parking spots, signs, signs painted on roads, traffic lights, or the like.

Because an HD map can be used to localize a vehicle, which can be performed to control movement of the vehicle, not only do positions of objects need to be indicated on the HD map with a high degree of accuracy, but also the HD map can be required to be updated at a high rate to account for changes in objects or positions of objects expected to be indicated on the HD map.

### SUMMARY

In an embodiment, a system for determining a set of information to be used to produce a map of a region can include a processor and a memory. The memory can store a set determination module, a production module, and a communications module. The set determination module can include instructions that, when executed by the processor, cause the processor to determine, from: (1) positions of a vehicle that traversed a region and (2) data affiliated with images produced by a camera on the vehicle, a set of information to be used to produce a map of the region. An optimal state of the set can be based on one or more of: (1) a characteristic of the information or (2) an aspect, in the region, to be included in the map. The production module can include instructions that, when executed by the processor, cause the processor to produce, from the set, the map. The communications module can include instructions that, when executed by the processor, cause the processor to transmit the map to a specific vehicle to control movement of the specific vehicle.

In another embodiment, a method for determining a set of information to be used to produce a map of a region can include determining, by a processor and from: (1) positions of a vehicle that traversed a region and (2) data affiliated with images produced by a camera on the vehicle, a set of information to be used to produce a map of the region. An optimal state of the set can be based on one or more of: (1) a characteristic of the information or (2) an aspect, in the region, to be included in the map. The method can include producing, by the processor and from the set, the map. The method can include transmitting, by the processor, the map to a specific vehicle to control movement of the specific vehicle.

In another embodiment, a non-transitory computer-readable medium for determining a set of information to be used to produce a map of a region can include instructions that, when executed by one or more processors, cause the one or more processors to determine, from: (1) positions of a vehicle that traversed a region and (2) data affiliated with images produced by a camera on the vehicle, a set of information to be used to produce a map of the region. An optimal state of the set can be based on one or more of: (1) a characteristic of the information or (2) an aspect, in the region, to be included in the map. The non-transitory computer-readable medium can include instructions that, when executed by one or more processors, cause the one or more processors to produce, from the set, the map. The non-transitory computer-readable medium can include instructions that, when executed by one or more processors, cause the one or more processors to transmit the map to a specific vehicle to control movement of the specific vehicle.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 includes a diagram that illustrates an example of an environment for determining a set of information to be used to produce a map of a region, according to the disclosed technologies.

FIG. 2 is a block diagram that illustrates an example of a system for determining a set of information to be used to produce a map of a region, according to the disclosed technologies.

FIG. 3 includes a flow diagram that illustrates an example of a method that is associated with determining a set of information to be used to produce a map of a region, according to the disclosed technologies.

FIG. 4 includes a block diagram that illustrates an example of elements disposed on a vehicle, according to the disclosed technologies.

### DETAILED DESCRIPTION

Simultaneous localization and mapping (SLAM) is a phrase that can refer to a technology that enables a mobile robot (e.g., an automated vehicle or an autonomous vehicle) to move through an unknown location while simultaneously determining a pose (i.e., a position and an orientation) of the vehicle at the location (i.e., localization) and mapping the location. Typically, a SLAM technique can operate over discrete units of time and use proprioception information to estimate a pose of the vehicle, and perceptual information to correct an estimate of the pose. Usually, the proprioception information can be one or more of global navigation satellite system (GNSS) information, inertial measurement unit (IMU) information, odometry information, or the like. For example, the odometry information can be a value included in a signal sent to a vehicle system (e.g., an accelerator). The perceptual information can often be one or more of point cloud information from a ranging sensor (e.g., a light detection and ranging (lidar) system), image data from one or more images from one or more image sensors or cameras, or the like.

For example, for a SLAM technique that uses point cloud information from a ranging sensor, the ranging sensor can provide the vehicle with distances and bearings to objects in the location and the SLAM technique can operate to identify salient objects as landmarks. For example, for a SLAM technique that uses image data from one or more images from one or more image sensors or cameras, which can be referred to as visual SLAM, distances and bearings to objects can be determined using a photogrammetric range imaging technique (e.g., a structure from motion (SfM) technique) applied to a sequence of two-dimensional images. Because a camera can be less expensive than a lidar device and more vehicles are equipped with cameras than with lidar devices, considerable effort has been expended to develop visual SLAM for use in producing geometric maps as layers of high-definition (HD) maps used to control movements of vehicles.

Moreover, although SLAM techniques were originally developed to operate in real-time (i.e., simultaneously localize and map), the use of SLAM techniques to produce geometric maps has led to the development of SLAM techniques that can operate in a setting other than in a moving vehicle. In such SLAM techniques, recordings of the proprioception information and the perceptual information can be used. Such SLAM techniques can be referred to as offline SLAM. By using the recordings of the proprioception information and the perceptual information, corrections to estimates of poses of a vehicle can be performed concurrently on one or more finite sequences of the discrete units of time over which the SLAM techniques were operated.

The recordings of the proprioception information and the perceptual information can be obtained, for example, by one or more probe vehicles. A probe vehicle can be a vehicle that intentionally performs one or more passes through a location to obtain the recordings of the proprioception information and the perceptual information.

Because an HD map can be used to localize a vehicle, which can be performed to control movement of a vehicle, inclusion of indications of certain objects (e.g., landmarks) on the HD map can be more important than others. Such important landmarks can include, for example, lane boundaries, road boundaries, road junctions (e.g., intersections, interchanges, etc.), crosswalks, bus lanes, parking spots, signs, signs painted on roads, traffic lights, or the like.

Additionally, for example, the data affiliated with the images can be received from a set of vehicles (e.g., probe vehicles). A set of cameras can be attached to the set of vehicles. For example, one camera, of the set of cameras, can be attached to one vehicle of the set of vehicles. For example, a camera, of the set of cameras, can produce images. For example, the images can be produced at a specific production rate. For example, the specific production rate can be ten hertz. For example, the camera can be a component in a lane keeping assist (LKA) system. For example: (1) the data affiliated with the images can be received, by a system that implements the disclosed technologies, from the set of vehicles (e.g., the probe vehicles) at a first time, (2) the digital map, produced by the system that implements the disclosed technologies and from the data, can be transmitted to the specific vehicle at a second time, and (3) a difference between the first time and the second time can be less than a specific duration of time. For example, the specific duration of time can be thirty minutes.

The disclosed technologies can produce the data affiliated with the images of the location using, for example, visual SLAM techniques. For example, a camera attached to a vehicle of the set of vehicles (e.g., a probe vehicle) can produce the images. For example, the images can be produced at a specific production rate. For example, the specific production rate can be ten hertz. Objects in the images can be detected using, for example, object detection techniques. Objects in the images can be recognized using, for example, object recognition techniques. Semantic information can be affiliated with the objects. For example, objects that qualify as landmarks can be determined. For example, the landmarks can include lane boundaries, road boundaries, road junctions (e.g., intersections, interchanges, etc.), crosswalks, bus lanes, parking spots, signs, signs painted on roads, traffic lights, or the like.

A lane boundary can separate one lane of a road from another lane of the road. A lane boundary can be indicated, for example, by one or more of road surface markings, observations of differences in pavement on a road, observations of trajectories of vehicles, or the like. The road surface markings for a lane boundary can be, for example, lane markings. The lane markings can be, for example, a series of dashed line segments along the lane boundary.

A road boundary can separate an improved surface for use by vehicles and pedestrians (e.g., a drivable surface (e.g., a road)) from other surfaces. A road boundary can be indicated by one or more of road surface markings, curbs, observations of differences of degrees of improvement between adjacent surfaces, or the like. The road surface markings for a road boundary can be, for example, a continuous line along the road boundary.

Because: (1) positions, not depictions, of landmarks in an HD map used to localize a vehicle, which can be performed to control movement of a vehicle, need to be indicated with a high degree of accuracy and (2) images of a location can be produced at a specific production rate, depictions of the landmarks likely can be included in several of the images of the location. However, for an image, of the images of the location, a position of any of a lane boundary of a lane of a road in the image, a road boundary of the road, or another landmark in the image can be represented by a position of a point on the lane boundary, the road boundary, or the other landmark. For example, the position of the point on the lane boundary, the road boundary, or the landmark can be affiliated with a position of a keypoint of an object, in the image, that represents the lane boundary, the road boundary, or the landmark. A keypoint can be a point in an object that has a potential of being repeatedly detected under different imaging conditions. Keypoints in objects can be extracted using, for example, keypoint extraction techniques.

The vehicle of the set of vehicles (e.g., the probe vehicle) can use, for example, proprioception information (e.g., one or more of GNSS information, IMU information, odometry information, or the like) to estimate a pose (i.e., a position and an orientation) of a camera (e.g., attached to the vehicle). The vehicle (e.g., the probe vehicle) can use, for example, as perceptual information, results of a photogrammetric range imaging technique (e.g., an SfM technique) to determine distances and bearings to the landmarks (e.g., keypoints) in the images. Positions of points (e.g., keypoints) on the landmarks can be determined, for example, using: (1) the pose of the camera (e.g., attached to the vehicle) and (2) the distances and the bearings to the landmarks (e.g., keypoints) in the images.

In this manner, the data affiliated with the images of the location can, for an image of the images, exclude pixel color data, but include information about one or more positions of points on landmarks in the image. For example, an amount of the data affiliated with the image can be less than a threshold amount. For example, the threshold amount can be 300 bytes. For example, the data affiliated with the images can be produced by an automated driving system of active safety technologies and advanced driver assistance systems (ADAS). For example, the automated driving system can be a third generation of the Toyota Safety Sense™ system (TSS3).

For example, for a vehicle of the set of vehicles (e.g., the probe vehicles), a transmission of a batch of the data affiliated with the images, produced by a camera of the vehicle of the set of vehicles (e.g., the probe vehicles), can be received in a specific duration of time. For example, the specific duration of time can be thirty seconds. For example, the transmission of the batch can be received at a specific communication rate. For example, the specific communication rate can be once per thirty seconds.

The disclosed technologies are directed to determining a set of information to be used to produce a map of a region so that even though a system that implements the disclosed technologies receives a relatively large amount of data both produced and communicated at a high rate (e.g., produced, for example, at ten hertz; and communicated, for example, once per thirty seconds), the system can produce, from this data, the digital map of the region in a relatively short duration of time (e.g., less than thirty minutes). The set of the information to be used to produce the map of the region can be determined from: (1) positions of a vehicle that traversed the region and (2) data affiliated with images produced by a camera on the vehicle. An optimal state of the set of the information can be based on one or more of: (1) a characteristic of the information or (2) an aspect, in the region, to be included in the map. For example, the positions of the vehicle can be included in a geographic position trace of the vehicle. For example, the geographic position trace can include a recording of a sequence of points. For example, the recording can include, for a point in the sequence of points, information about: (1) a position of the point and (2) a time at which the position was documented. For example, the data affiliated with the images can exclude pixel color data. For example: (1) the aspect, in the region, can include a portion of a road, (2) the data affiliated with the images can include information about positions of points for a road boundary of the portion of the road, and (3) the road boundary can be represented as an object in an image in the images. For example, a point, of the points for the road boundary, can be a keypoint of the object. For example, a determination of the set of the information can include a determination, based on the positions of the vehicle and the positions of the points for the road boundary, one or more positions of one or more lanes of the road. The map can be produced from the set of the information. The map can be transmitted to a specific vehicle to control movement of the specific vehicle.

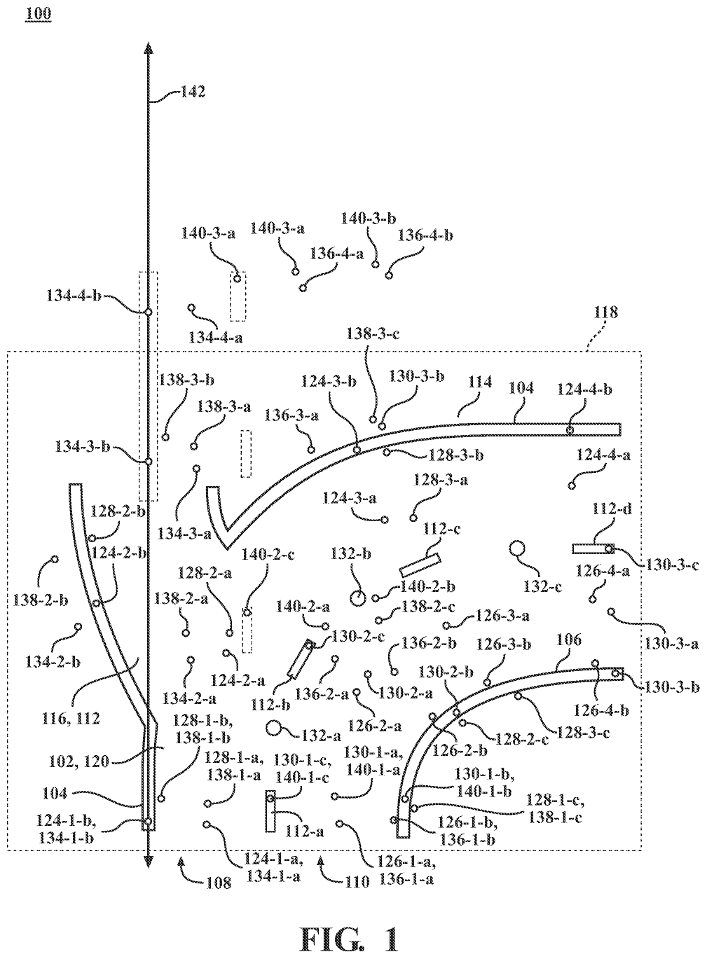

FIG. 1 includes a diagram 100 that illustrates an example of an environment for determining a set of information to be used to produce a map of a region, according to the disclosed technologies. For example, the diagram 100 can include a road 102. For example, the road 102 can have a left road boundary 104 and a right road boundary 106. For example, the road 102 can have a left lane 108 and a right lane 110 separated by lane boundaries 112. For example, the lane boundaries 112 can include a first lane boundary 112-a, a second lane boundary 112-b, a third lane boundary 112-c, and a fourth lane boundary 112-d. For example, a curve 114 can exist in the road 102. For example, the diagram 100 can further include a landmark 116 (e.g., a road junction (e.g., an interchange (e.g., an offramp))). For example, the diagram 100 can include a region 118 for which the map is to be produced. For example, the region 118 can include a first aspect 120 and a second aspect 122. For example, the first aspect 120 can include a portion of the road. For example, the second aspect 122 can include the landmark 116.

For example, the diagram 100 can include data affiliated with a first traversal 124 of the region 118, data affiliated with a second traversal 126 of the region 118, data affiliated with a third traversal 128 of the region 118, and data affiliated with a fourth traversal 130 of the region 118. For example, the data affiliated with the first traversal 124 can include, a sequence, a first set of data: 124-1, a second set of data 124-2, a third set of data 124-3, and a fourth set of data 124-4. For example, the data affiliated with the second traversal 126 can include, a sequence, a first set of data: 126-1, a second set of data 126-2, a third set of data 126-3, and a fourth set of data 126-4. For example, the data affiliated with the third traversal 128 can include, a sequence, a first set of data: 128-1, a second set of data 128-2, and a third set of data 128-3. For example, the data affiliated with the fourth traversal 130 can include, a sequence, a first set of data: 130-1, a second set of data 130-2, and a third set of data 130-3.

For example, the first set of data 124-1 can include a position 124-1-a of a vehicle and a position 124-1-b of the left road boundary 104. For example, the second set of data 124-2 can include a position 124-2-a of the vehicle and a position 124-2-b of the landmark 116. For example, the third set of data 124-3 can include a position 124-3-a of the vehicle and a position 124-3-b of the left road boundary 104. For example, the fourth set of data 124-4 can include a position 124-4-a of the vehicle and a position 124-4-b of the left road boundary 104.

For example, the first set of data 126-1 can include a position 126-1-a of a vehicle and a position 126-1-b of the right road boundary 106. For example, the second set of data 126-2 can include a position 126-2-a of the vehicle and a position 126-2-b of the right road boundary 106. For example, the third set of data 126-3 can include a position 126-3-a of the vehicle and a position 126-3-b of the right road boundary 106. For example, the fourth set of data 126-4 can include a position 126-4-a of the vehicle and a position 126-4-b of the right road boundary 106.

For example, the first set of data 128-1 can include a position 128-1-a of a vehicle, a position 128-1-b of the left road boundary 104, and a position 128-1-c of the right road boundary 106. For example, the second set of data 128-2 can include a position 128-2-a of the vehicle, a position 128-2-b of the landmark 116, and a position 128-2-c of the right road boundary 106. For example, the third set of data 128-3 can include a position 128-3-a of the vehicle, a position 128-3-b of the left road boundary 104, and a position 128-3-c of the right road boundary 106.

For example, the first set of data 130-1 can include a position 130-1-a of a vehicle, a position 130-1-b of the right road boundary 106, and a position 130-1-c of the first lane boundary 112-a. For example, the second set of data 130-2 can include a position 130-2-a of the vehicle, a position 130-2-b of the right road boundary 106, and a position 130-2-c of the second lane boundary 112-b. For example, the third set of data 130-3 can include a position 130-3-a of the vehicle, a position 130-3-b of the right road boundary 106, and a position 130-3-c of the fourth lane boundary 112-d.

For example, the diagram 100 can include positions of a center 132 of the road 102. For example, the positions of the center 132 can include a first position of the center 132-a, a second position of the center 132-b, and a third position of the center 132-c.

For example, the diagram 100 can include a reposition 134-1-a of a vehicle, a reposition 134-1-b of the left road boundary 104, a reposition 134-2-a of the vehicle, a reposition 134-2-b of the landmark 116, a reposition 134-3-a of the vehicle, a reposition 134-3-b of the left road boundary 104, a reposition 134-4-a of the vehicle, and a reposition 134-4-b of the left road boundary 104.

For example, the diagram 100 can include a reposition 136-1-a of a vehicle, a reposition 136-1-b of the right road boundary 106, a reposition 136-2-a of the vehicle, a reposition 136-2-b of the right road boundary 106, a reposition 136-3-a of the vehicle, a reposition 136-3-b of the right road boundary 106, a reposition 136-4-a of the vehicle, and a reposition 136-4-b of the right road boundary 106.

For example, the diagram 100 can include a reposition 138-1-a of a vehicle, a reposition 138-1-b of the left road boundary 104, a reposition 138-1-c of the right road boundary 106, a reposition 138-2-a of the vehicle, a reposition 138-2-b of the landmark 116, a reposition 138-2-c of the right road boundary 106, a reposition 138-3-a of the vehicle, a reposition 138-3-b of the left road boundary 104, and a reposition 138-3-c of the right road boundary 106.

For example, the diagram 100 can include a reposition 140-1-a of a vehicle, a reposition 140-1-b of the right road boundary 106, a reposition 140-1-c of the first lane boundary 112-a, a reposition 140-2-a of the vehicle, a reposition 140-2-b of the right road boundary 106, a reposition 140-2-c of the second lane boundary 112-b, a reposition 140-3-a of the vehicle, a reposition 140-3-b of the right road boundary 106, and a reposition 140-3-c of the fourth lane boundary 112-d. For example, the diagram 100 can include a line 142.

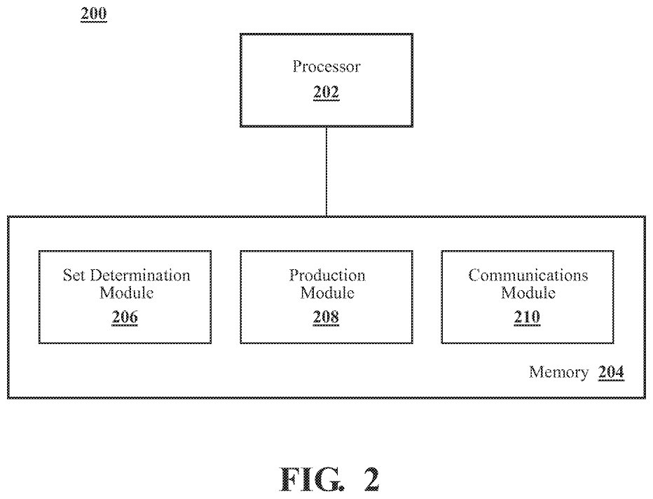

FIG. 2 is a block diagram that illustrates an example of a system 200 for determining a set of information to be used to produce a map of a region, according to the disclosed technologies. The system 200 can include, for example, a processor 202 and a memory 204. The memory 204 can be communicably coupled to the processor 202. For example, the memory 204 can store a set determination module 206, a production module 208, and a communications module 210.

For example, the set determination module 206 can include instructions that function to control the processor 202 to determine, from: (1) positions of a vehicle that traversed the region and (2) data affiliated with images produced by a camera on the vehicle, the set of the information to be used to produce the map of the region. An optimal state of the set of the information can be based on one or more of: (1) a characteristic of the information or (2) an aspect, in the region, to be included in the map.

For example, the production module 208 can include instructions that function to control the processor 202 to produce, from the set of the information, the map.

For example, the communications module 210 can include instructions that function to control the processor 202 to transmit the map to a specific vehicle to control movement of the specific vehicle.

For example, the communications module 210 can further include instructions to receive, from the vehicle, the positions of the vehicle and the data affiliated with the images.

For example, the geographic position trace can include a recording of a sequence of points. For example, the recording can include, for a point in the sequence of points, information about: (1) a position of the point and (2) a time at which the position was documented. For example, the position of the point can be expressed as a latitude of the point and a longitude of the point. For example, the position of the point can be a position of the camera on the vehicle. For example, the recording can further include, for the point, information about a height of the point with respect to a reference height. For example, the reference height can be sea level. For example, the position of the point can be determined from proprioception information affiliated with the vehicle. For example, the proprioception information can include one or more of global navigation satellite system information, inertial measurement unit information, odometry information, or the like.

With reference to FIG. 1, for example, the first set of data 124-1 can include the position 124-1-a of a vehicle, the second set of data 124-2 can include the position 124-2-a of the vehicle, the third set of data 124-3 can include the position 124-3-a of the vehicle, and the fourth set of data 124-4 can include the position 124-4-a of the vehicle. For example, the first set of data 126-1 can include the position 126-1-a of a vehicle, the second set of data 126-2 can include the position 126-2-a of the vehicle, the third set of data 126-3 can include the position 126-3-a of the vehicle, and the fourth set of data 126-4 can include the position 126-4-a of the vehicle. For example, the first set of data 128-1 can include the position 128-1-a of a vehicle, the second set of data 128-2 can include the position 128-2-a of the vehicle, and the third set of data 128-3 can include the position 128-3-a of the vehicle. For example, the first set of data 130-1 can include the position 130-1-a of a vehicle, the second set of data 130-2 can include the position 130-2-a of the vehicle, and the third set of data 130-3 can include the position 130-3-a of the vehicle.

For example, the data affiliated with the images can exclude pixel color data. For example: (1) the aspect, in the region, can include a portion of a road, (2) the data affiliated with the images can include information about positions of points for a road boundary of the portion of the road, and (3) the road boundary can be represented as an object in an image in the images. For example, a point, of the points for the road boundary, can be a keypoint of the object.

With reference to FIG. 1, for example, the first set of data 124-1 can include the position 124-1-b of the left road boundary 104, the third set of data 124-3 can include the position 124-3-b of the left road boundary 104, and the fourth set of data 124-4 can include the position 124-4-b of the left road boundary 104. For example, the first set of data 126-1 can include the position 126-1-b of the right road boundary 106, the second set of data 126-2 can include the position 126-2-b of the right road boundary 106, the third set of data 126-3 can include the position 126-3-b of the right road boundary 106, and the fourth set of data 126-4 can include the position 126-4-b of the right road boundary 106. For example, the first set of data 128-1 can include the position 128-1-b of the left road boundary 104 and the position 128-1-c of the right road boundary 106, the second set of data 128-2 can include the position 128-2-c of the right road boundary 106, and the third set of data 128-3 can include the position 128-3-b of the left road boundary 104 and the position 128-3-c of the right road boundary 106. For example, the first set of data 130-1 can include the position 130-1-b of the right road boundary 106, the second set of data 130-2 can include the position 130-2-b of the right road boundary 106, and the third set of data 130-3 can include the position 130-3-b of the right road boundary 106.

For example, the instructions to determine the set of information can include instructions to determine, based on the positions of the vehicle and the positions of the points for the road boundary, one or more positions of one or more lanes of the road.

In a variation, for example, the instructions to determine the position of the one or more lanes of the road can include instructions to determine, based on the positions of the vehicle, the positions of the points for the road boundary, and one or more positions of a center of the road, the one or more positions of the one or more lanes of the road. For example, the communications module 210 can further include instructions to receive, from an external source, information about the one or more positions of the center of the road. For example, the external source can be a geographic database. For example, the geographic database can be the OpenStreetMap geographic database maintained by OpenStreetMap Foundation of Cambridge, United Kingdom.

With reference to FIG. 1, for example, the positions of the center 132 of the road 102 can include the first position of the center 132-a, the second position of the center 132-b, and the third position of the center 132-c.

In another variation, for example, the road boundary can include a first road boundary and a second road boundary. For example, the portion of the road can be located between the first road boundary and the second road boundary. For example, the instructions to determine the one or more positions of the one or more lane of the road can include instructions to determine, based on the positions of the vehicle, the positions of the points for the first road boundary, and the positions of the points for the second road boundary, the one or more position of the one or more lanes of the road.

Again, with reference to FIG. 1, for example, the first set of data 124-1 can include the position 124-1-b of the left road boundary 104, the third set of data 124-3 can include the position 124-3-b of the left road boundary 104, and the fourth set of data 124-4 can include the position 124-4-b of the left road boundary 104. For example, the first set of data 126-1 can include the position 126-1-b of the right road boundary 106, the second set of data 126-2 can include the position 126-2-b of the right road boundary 106, the third set of data 126-3 can include the position 126-3-b of the right road boundary 106, and the fourth set of data 126-4 can include the position 126-4-b of the right road boundary 106. For example, the first set of data 128-1 can include the position 128-1-b of the left road boundary 104 and the position 128-1-c of the right road boundary 106, the second set of data 128-2 can include the position 128-2-c of the right road boundary 106, and the third set of data 128-3 can include the position 128-3-b of the left road boundary 104 and the position 128-3-c of the right road boundary 106. For example, the first set of data 130-1 can include the position 130-1-b of the right road boundary 106, the second set of data 130-2 can include the position 130-2-b of the right road boundary 106, and the third set of data 130-3 can include the position 130-3-b of the right road boundary 106.

In yet another variation, for example, the instructions to determine the one or more positions of the one or more lanes of the road can include: (1) instructions to determine, based on the positions of the vehicle and the positions of the points for the road boundary, an existence of a curve in the portion of the road, (2) instructions to cause a repositioning of the positions of the vehicle and the positions of the points for the road boundary so that after the repositioning: (a) the curve is coincidental with a line and (b) a relative position, between a position of one point, of one or more of the positions of the vehicle or the positions of the points for the road boundary, and a position of another point, of the one or more of the positions of the vehicle or the positions of the points for the road boundary, can be a same as the relative position before the repositioning, and (3) instructions to determine, after the repositioning, the one or more positions of the one or more lanes of the road.

With reference to FIG. 1, for example, the curve 114 can exist in the road 102. For example, the diagram 100 can include the reposition 134-1-a of a vehicle, the reposition 134-1-b of the left road boundary 104, the reposition 134-2-a of the vehicle, the reposition 134-3-a of the vehicle, the reposition 134-3-b of the left road boundary 104, the reposition 134-4-a of the vehicle, the reposition 134-4-b of the left road boundary 104, the reposition 136-1-a of a vehicle, the reposition 136-1-b of the right road boundary 106, the reposition 136-2-a of the vehicle, the reposition 136-2-b of the right road boundary 106, the reposition 136-3-a of the vehicle, the reposition 136-3-b of the right road boundary 106, the reposition 136-4-a of the vehicle, the reposition 136-4-b of the right road boundary 106, the reposition 138-1-a of a vehicle, the reposition 138-1-b of the left road boundary 104, the reposition 138-1-c of the right road boundary 106, the reposition 138-2-a of the vehicle, the reposition 138-2-c of the right road boundary 106, the reposition 138-3-a of the vehicle, the reposition 138-3-b of the left road boundary 104, the reposition 138-3-c of the right road boundary 106, the reposition 140-1-a of a vehicle, the reposition 140-1-b of the right road boundary 106, the reposition 140-2-a of the vehicle, the reposition 140-2-b of the right road boundary 106, the reposition 140-3-a of the vehicle, and the reposition 140-3-b of the right road boundary 106. For example, the diagram 100 can include the line 142.

Additionally, in an implementation of the disclosed technologies, for example, the vehicle that traversed the region can be associated with a plurality of traversals. For example, the plurality of traversals can be associated with one or more of: (1) a vehicle that traversed, on a plurality of occasions, the region (e.g., a single vehicle that traversed the region on a plurality of occasions) or (2) a plurality of vehicles that traversed, on a plurality of occasions, the region (e.g., several vehicles that collectively traversed the region on a plurality of occasions). For example, if the plurality of traversals is associated with a plurality of vehicles, then a plurality of cameras can be on the plurality of vehicles (e.g., at least one camera on a vehicle).

Additionally, in this implementation, for example, the positions of each of the plurality of traversals can have a length within the region. For example, a set of the positions of the each of the plurality of traversals can include the positions of the each of the plurality of traversals in which the length within the region is greater than a threshold length. For example, the optimal state of the set of the information can include a count of elements in the set of the positions of the each of the plurality of traversals being greater than a threshold count.

With reference to FIG. 1, for example, the region can be the region 118. For example, a length of the positions affiliated with the third traversal 128 can be shorter than a length of the positions affiliated with each of the first traversal 124, the second traversal 126, and the fourth traversal 130. For example, if the length of the positions affiliated with the third traversal 128 is less than the threshold length, then the positions affiliated with the third traversal 128 can be excluded from the set of the positions. For example, if the length of the positions affiliated with each of the first traversal 124, the second traversal 126, and the fourth traversal 130 is greater than the threshold length, then each of the first traversal 124, the second traversal 126, and the fourth traversal 130 can be included in the set of the positions. For example, if the count of the elements in the set of the positions (i.e., three) is greater than the threshold count, then the set of the positions can be in the optimal state.

Additionally or alternatively, in this implementation, for example, the positions of each of the plurality of traversals can include positions of points in a sequence of points. For example, a set of the positions of the each of the plurality of traversals can include the positions of the each of the plurality of traversals in which an average distance between a position of a point in the sequence and a position of an immediately subsequent point in the sequence is less than a threshold distance. For example, the optimal state of the set of the information can include a count of elements in the set of the positions of the each of the plurality of traversals being greater than a threshold count.

For example, having the average distance between the position of the point in the sequence and the position of the immediately subsequent point in the sequence being greater than the threshold distance can be indicative that a characteristic of the information is that the information includes one or more gaps in the sequence of points. For example, the one or more gaps can be caused by one or more reasons. For example, the vehicle may have failed, for a short duration of time, to receive proprioception information (e.g., the one or more of the GNSS information, the IMU information, the odometry information, or the like). Additionally or alternatively, for example, the vehicle may have had, for a short duration of time, an interruption of communications between the vehicle and the system 200 for determining the set of the information to be used to produce the map of the region. Additionally or alternatively, for example, the data affiliated with a specific image, of the images produced by the camera on the vehicle, may include personal data. For example, such personal data may include personally identifiable information (PII) (e.g., face recognition information). In such a situation, for example, the data affiliated with the specific image may have intentionally been prevented from being transmitted by the vehicle to the system 200 for determining the set of the information to be used to produce the map of the region. Additionally, one of skill in the art, in light of the description herein, understands that the one or more gaps can be caused by one or more other reasons.

With reference to FIG. 1, for example, a distance between the position 130-3-a and the position 130-2-a can be longer than a distance between the position 130-2-a and the position 130-1-a. For example, an average distance, between a position of a point in a sequence and a position of an immediately subsequent point in the sequence, affiliated with the fourth traversal 130 can be longer than an average distance, between a position of a point in a sequence and a position of an immediately subsequent point in the sequence, affiliated with each of the first traversal 124, the second traversal 126, and the third traversal 128. For example, if the average distance, between a position of a point in a sequence and a position of an immediately subsequent point in the sequence, affiliated with the fourth traversal 130 is greater than the threshold distance, then then the positions affiliated with the fourth traversal 130 can be excluded from the set of the positions. For example, if the average distance, between a position of a point in a sequence and a position of an immediately subsequent point in the sequence, affiliated with each of the first traversal 124, the second traversal 126, and the third traversal 128 is less than the threshold distance, then each of the first traversal 124, the second traversal 126, and the third traversal 128 can be included in the set of the positions. For example, if the count of the elements in the set of the positions (i.e., three) is greater than the threshold count, then the set of the positions can be in the optimal state.

Additionally or alternatively, in a variation of this implementation, for example, the plurality of occasions can include a first set of the plurality of occasions and a second set of the plurality of occasions. For example, the one or more lanes can include a first lane and a second lane. For example, the first set of the plurality of occasions can be affiliated with traversals of the first lane. For example, the second set of the plurality of occasions can be affiliated with traversals of the second lane.

With reference to FIG. 1, for example, the first set of the plurality of occasions affiliated with traversals of the left lane 108 can be affiliated with the first traversal 124 and the third traversal 128. For example, the second set of the plurality of occasions affiliated with traversals of the right lane 110 can be affiliated with the second traversal 126 and the fourth traversal 130.

For example, in this variation of this implementation, the instructions to determine the one or more positions of the one or more lanes of the road can include instructions to determine a position of the road boundary. For example, the instructions to determine the position of the road boundary can include instructions to interpolate among: (1) the positions of the points for the road boundary affiliated with the traversals of the first lane and (2) the positions of the points for the road boundary affiliated with the traversals of the second lane. For example, the instructions to interpolate can include instructions to perform a distance-weighted interpolation.

With reference to FIG. 1, for example, the position of the right road boundary 106 can be determined from an interpolation among the position 126-1-b and the position 128-1-b. For example, the interpolation can be a distance-weighted interpolation in which more weight is applied to the position 126-1-b than to the position 128-1-b because the position 126-1-b is affiliated with the second traversal 126 of the right lane 110 while the position 128-1-b is affiliated with the third traversal 128 of the left lane 108.

Additionally, in this variation of this implementation, for example, the instructions to determine the one or more positions of the one or more lanes of the road can further include instructions to determine a position of a lane boundary of the one or more lanes. For example, the instructions to determine the position of the lane boundary can include instructions to interpolate among: (1) the positions of the points for the lane boundary affiliated with the traversals of the first lane and (2) the positions of the points for the lane boundary affiliated with the traversals of the second lane. For example, the instructions to interpolate can include instructions to perform a distance-weighted interpolation.

For example, in this variation of this implementation, the optimal state of the set of the information can include: (1) a count of the positions of the plurality of traversals affiliated with the traversals of the first lane being substantially equal to (2) a count of the positions of the plurality of traversals affiliated with the traversals of the second lane. For example, having the count of the positions of the plurality of traversals affiliated with the traversals of the first lane be substantially equal to the count of the positions of the plurality of traversals affiliated with the traversals of the second lane can be understood to mean that the count of the positions of the plurality of traversals affiliated with the traversals of the first lane is within plus or minus ten percent of the count of the positions of the plurality of traversals affiliated with the traversals of the second lane.

Again, with reference to FIG. 1, for example, the first set of the plurality of occasions affiliated with traversals of the left lane 108 can be affiliated with the first traversal 124 and the third traversal 128. For example, the second set of the plurality of occasions affiliated with traversals of the right lane 110 can be affiliated with the second traversal 126 and the fourth traversal 130. Because the count (i.e., two) of the plurality of traversals affiliated with the traversals of the left lane 108 is substantially equal to the count (i.e., two) of the plurality of traversals affiliated with the traversals of the right lane 110, the set of the positions can be in the optimal state.

Additionally or alternatively, in this variation of this implementation, for example, the optimal state of the set of the information can include a count of each of: (1) the positions of the plurality of traversals affiliated with the traversals of the first lane and (2) the positions of the plurality of traversals affiliated with the traversals of the second lane being greater than a first threshold (i.e., to include enough data so that the map can be produced with a high degree of accuracy), but less than a second threshold (i.e., to set a limit on an amount of the data so that the map can be produced in a relatively short duration of time). For example, a technique can be performed on the set of the information to determine which of the positions of the plurality of traversals to be included in the optimal state of the set of the information and which of the positions of the plurality of traversals to be excluded from the optimal state of the set of the information.

Again, with reference to FIG. 1, for example, if the first threshold is zero and the second threshold is five, then because each of: (1) the count (i.e., two) of the plurality of traversals affiliated with the traversals of the left lane 108 and (2) the count (i.e., two) of the plurality of traversals affiliated with the traversals of the right lane 110, are greater than the first threshold, but less than the second threshold the set of the positions can be in the optimal state.

Additionally or alternatively, in an extension of this variation of this implementation, for example: (1) the aspect, in the region, can further include a landmark, (2) the data affiliated with the images can further include information about positions of points for a landmark, and (3) the landmark can be represented as another object in the image. For example, the landmark can be a road junction. For example, the road junction can be an interchange (e.g., an offramp). For example, the plurality of traversals can include a first set of the plurality of traversals and a second set of the plurality of traversals. For example, the data affiliated with the images affiliated with the first set of the plurality of traversals can include the information about the positions of the points for the landmark. For example, the data affiliated with the images affiliated with the second set of the plurality of traversals can lack the information about the positions of the points for the landmark. For example, the optimal state of the set of the information can include information affiliated with one or more traversals of the first set of the plurality of traversals.

With reference to FIG. 1, for example, the landmark can be the landmark 116. For example: (1) the second set of data 124-2 can include the position 124-2-b of the landmark 116 and (2) the second set of data 128-2 can include the position 128-2-b of the landmark 116. For example, the first set of the plurality of traversals can include the first traversal 124 and the third traversal 128. For example, the second set of the plurality of traversals can include the second traversal 126 and the fourth traversal 130. For example, the optimal state of the set of the information can include information affiliated with one or more of the first traversal 124 or the third traversal 128.

Additionally, in this extension of this variation of this implementation, for example, the first lane can be nearer to the landmark than the second lane. For example, the one or more traversals of the first set of the plurality of traversals can include one or more traversals of the first set of the plurality of occasions.

Again, with reference to FIG. 1, for example, because: (1) the left lane 108 is nearer to the landmark 116 than the right lane 110 and (2) the first traversal 124 is a traversal of the left lane 108, the optimal state of the set of the information can include information affiliated with the first traversal 124.

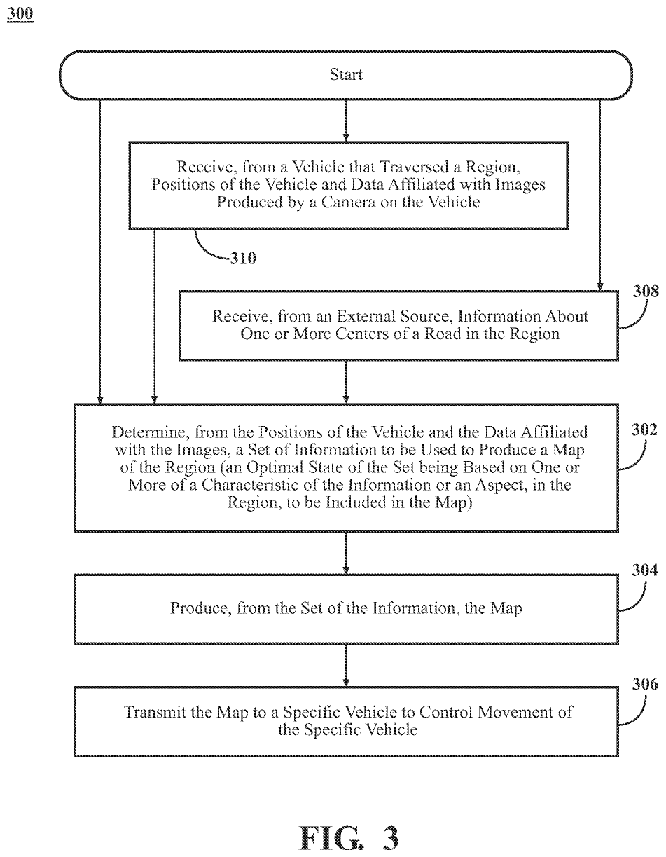

FIG. 3 includes a flow diagram that illustrates an example of a method 300 that is associated with determining a set of information to be used to produce a map of a region, according to the disclosed technologies. Although the method 300 is described in combination with the system 200 illustrated in FIG. 2, one of skill in the art understands, in light of the description herein, that the method 300 is not limited to being implemented by the system 200 illustrated in FIG. 2. Rather, the system 200 illustrated in FIG. 2 is an example of a system that may be used to implement the method 300. Additionally, although the method 300 is illustrated as a generally serial process, various aspects of the method 300 may be able to be executed in parallel.

In FIG. 3, in the method 300, at an operation 302, for example, the set determination module 206 can determine, from: (1) positions of a vehicle that traversed the region and (2) data affiliated with images produced by a camera on the vehicle, the set of the information to be used to produce the map of the region. An optimal state of the set of the information can be based on one or more of: (1) a characteristic of the information or (2) an aspect, in the region, to be included in the map.

At an operation 304, for example, the production module 208 can produce, from the set of the information, the map.

At an operation 306, for example, the communications module 210 can transmit the digital map to a specific vehicle to control movement of the specific vehicle.

Additionally, at an operation 308, for example, the communications module 210 can receive, from the vehicle, the positions of the vehicle and the data affiliated with the images.

For example, the geographic position trace can include a recording of a sequence of points. For example, the recording can include, for a point in the sequence of points, information about: (1) a position of the point and (2) a time at which the position was documented. For example, the position of the point can be expressed as a latitude of the point and a longitude of the point. For example, the position of the point can be a position of the camera on the vehicle. For example, the recording can further include, for the point, information about a height of the point with respect to a reference height. For example, the reference height can be sea level. For example, the position of the point can be determined from proprioception information affiliated with the vehicle. For example, the proprioception information can include one or more of global navigation satellite system information, inertial measurement unit information, odometry information, or the like.

For example, the data affiliated with the images can exclude pixel color data. For example: (1) the aspect, in the region, can include a portion of a road, (2) the data affiliated with the images can include information about positions of points for a road boundary of the portion of the road, and (3) the road boundary can be represented as an object in an image in the images. For example, a point, of the points for the road boundary, can be a keypoint of the object.

For example, at the operation 302, the set determination module 206 can determine, based on the positions of the vehicle and the positions of the points for the road boundary, one or more positions of one or more lanes of the road.

In a variation, for example, at the operation 302, the set determination module 206 can determine, based on the positions of the vehicle, the positions of the points for the road boundary, and one or more positions of a center of the road, the one or more positions of the one or more lanes of the road. For example, at an operation 310, the communications module 210 can receive, from an external source, information about the one or more positions of the center of the road. For example, the external source can be a geographic database. For example, the geographic database can be the OpenStreetMap geographic database maintained by OpenStreetMap Foundation of Cambridge, United Kingdom.

In another variation, for example, the road boundary can include a first road boundary and a second road boundary. For example, the portion of the road can be located between the first road boundary and the second road boundary. For example, at the operation 302, the set determination module 206 can determine, based on the positions of the vehicle, the positions of the points for the first road boundary, and the positions of the points for the second road boundary, the one or more position of the one or more lanes of the road.

In yet another variation, for example, at the operation 302, the set determination module 206 can: (1) determine, based on the positions of the vehicle and the positions of the points for the road boundary, an existence of a curve in the portion of the road, (2) cause a repositioning of the positions of the vehicle and the positions of the points for the road boundary so that after the repositioning: (a) the curve is coincidental with a line and (b) a relative position, between a position of one point, of one or more of the positions of the vehicle or the positions of the points for the road boundary, and a position of another point, of the one or more of the positions of the vehicle or the positions of the points for the road boundary, can be a same as the relative position before the repositioning, and (3) determine, after the repositioning, the one or more positions of the one or more lanes of the road.

Additionally, in an implementation of the disclosed technologies, for example, the vehicle that traversed the region can be associated with a plurality of traversals. For example, the plurality of traversals can be associated with one or more of: (1) a vehicle that traversed, on a plurality of occasions, the region (e.g., a single vehicle that traversed the region on a plurality of occasions) or (2) a plurality of vehicles that traversed, on a plurality of occasions, the region (e.g., several vehicles that collectively traversed the region on a plurality of occasions). For example, if the plurality of traversals is associated with a plurality of vehicles, then a plurality of cameras can be on the plurality of vehicles (e.g., at least one camera on a vehicle).

Additionally, in this implementation, for example, the positions of each of the plurality of traversals can have a length within the region. For example, a set of the positions of the each of the plurality of traversals can include the positions of the each of the plurality of traversals in which the length within the region is greater than a threshold length. For example, the optimal state of the set of the information can include a count of elements in the set of the positions of the each of the plurality of traversals being greater than a threshold count.

Additionally or alternatively, in this implementation, for example, the positions of each of the plurality of traversals can include positions of points in a sequence of points. For example, a set of the positions of the each of the plurality of traversals can include the positions of the each of the plurality of traversals in which an average distance between a position of a point in the sequence and a position of an immediately subsequent point in the sequence is less than a threshold distance. For example, the optimal state of the set of the information can include a count of elements in the set of the positions of the each of the plurality of traversals being greater than a threshold count.

For example, having the average distance between the position of the point in the sequence and the position of the immediately subsequent point in the sequence being greater than the threshold distance can be indicative that a characteristic of the information is that the information includes one or more gaps in the sequence of points. For example, the one or more gaps can be caused by one or more reasons. For example, the vehicle may have failed, for a short duration of time, to receive proprioception information (e.g., the one or more of the GNSS information, the IMU information, the odometry information, or the like). Additionally or alternatively, for example, the vehicle may have had, for a short duration of time, an interruption of communications between the vehicle and the system 200 for determining the set of the information to be used to produce the map of the region. Additionally or alternatively, for example, the data affiliated with a specific image, of the images produced by the camera on the vehicle, may include personal data. For example, such personal data may include personally identifiable information (PII) (e.g., face recognition information). In such a situation, for example, the data affiliated with the specific image may have intentionally been prevented from being transmitted by the vehicle to the system 200 for determining the set of the information to be used to produce the map of the region. Additionally, one of skill in the art, in light of the description herein, understands that the one or more gaps can be caused by one or more other reasons.

Additionally or alternatively, in a variation of this implementation, for example, the plurality of occasions can include a first set of the plurality of occasions and a second set of the plurality of occasions. For example, the one or more lanes can include a first lane and a second lane. For example, the first set of the plurality of occasions can be affiliated with traversals of the first lane. For example, the second set of the plurality of occasions can be affiliated with traversals of the second lane.

For example, in this variation of this implementation, at the operation 302, the set determination module 206 can determine a position of the road boundary. For example, at the operation 302, the set determination module 206 can interpolate among: (1) the positions of the points for the road boundary affiliated with the traversals of the first lane and (2) the positions of the points for the road boundary affiliated with the traversals of the second lane. For example, at the operation 302, the set determination module 206 can perform a distance-weighted interpolation.

Additionally, in this variation of this implementation, for example, at the operation 302, the set determination module 206 can further determine a position of a lane boundary of the one or more lanes. For example, at the operation 302, the set determination module 206 can interpolate among: (1) the positions of the points for the lane boundary affiliated with the traversals of the first lane and (2) the positions of the points for the lane boundary affiliated with the traversals of the second lane. For example, at the operation 302, the set determination module 206 can perform a distance-weighted interpolation.

For example, in this variation of this implementation, the optimal state of the set of the information can include: (1) a count of the positions of the plurality of traversals affiliated with the traversals of the first lane being substantially equal to (2) a count of the positions of the plurality of traversals affiliated with the traversals of the second lane. For example, having the count of the positions of the plurality of traversals affiliated with the traversals of the first lane be substantially equal to the count of the positions of the plurality of traversals affiliated with the traversals of the second lane can be understood to mean that the count of the positions of the plurality of traversals affiliated with the traversals of the first lane is within plus or minus ten percent of the count of the positions of the plurality of traversals affiliated with the traversals of the second lane.

Additionally or alternatively, in this variation of this implementation, for example, the optimal state of the set of the information can include a count of each of: (1) the positions of the plurality of traversals affiliated with the traversals of the first lane and (2) the positions of the plurality of traversals affiliated with the traversals of the second lane being greater than a first threshold (i.e., to include enough data so that the map can be produced with a high degree of accuracy), but less than a second threshold (i.e., to set a limit on an amount of the data so that the map can be produced in a relatively short duration of time). For example, a technique can be performed on the set of the information to determine which of the positions of the plurality of traversals to be included in the optimal state of the set of the information and which of the positions of the plurality of traversals to be excluded from the optimal state of the set of the information.

Additionally or alternatively, in an extension of this variation of this implementation, for example: (1) the aspect, in the region, can further include a landmark, (2) the data affiliated with the images can further include information about positions of points for a landmark, and (3) the landmark can be represented as another object in the image. For example, the landmark can be a road junction. For example, the road junction can be an interchange (e.g., an offramp). For example, the plurality of traversals can include a first set of the plurality of traversals and a second set of the plurality of traversals. For example, the data affiliated with the images affiliated with the first set of the plurality of traversals can include the information about the positions of the points for the landmark. For example, the data affiliated with the images affiliated with the second set of the plurality of traversals can lack the information about the positions of the points for the landmark. For example, the optimal state of the set of the information can include information affiliated with one or more traversals of the first set of the plurality of traversals.

Additionally, in this extension of this variation of this implementation, for example, the first lane can be nearer to the landmark than the second lane. For example, the one or more traversals of the first set of the plurality of traversals can include one or more traversals of the first set of the plurality of occasions.

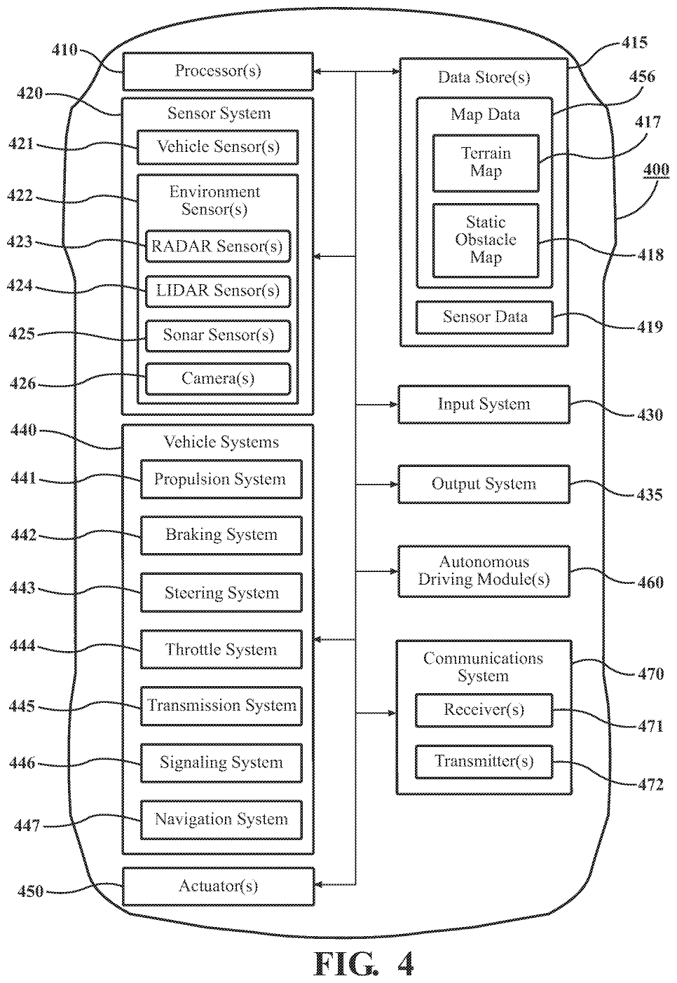

FIG. 4 includes a block diagram that illustrates an example of elements disposed on a vehicle 400, according to the disclosed technologies. As used herein, a “vehicle” can be any form of powered transport. In one or more implementations, the vehicle 400 can be an automobile. While arrangements described herein are with respect to automobiles, one of skill in the art understands, in light of the description herein, that embodiments are not limited to automobiles.

In some embodiments, the vehicle 400 can be configured to switch selectively between an automated mode, one or more semi-automated operational modes, and/or a manual mode. Such switching can be implemented in a suitable manner, now known or later developed. As used herein, “manual mode” can refer that all of or a majority of the navigation and/or maneuvering of the vehicle 400 is performed according to inputs received from a user (e.g., human driver). In one or more arrangements, the vehicle 400 can be a conventional vehicle that is configured to operate in only a manual mode.

In one or more embodiments, the vehicle 400 can be an automated vehicle. As used herein, “automated vehicle” can refer to a vehicle that operates in an automated mode. As used herein, “automated mode” can refer to navigating and/or maneuvering the vehicle 400 along a travel route using one or more computing systems to control the vehicle 400 with minimal or no input from a human driver. In one or more embodiments, the vehicle 400 can be highly automated or completely automated. In one embodiment, the vehicle 400 can be configured with one or more semi-automated operational modes in which one or more computing systems perform a portion of the navigation and/or maneuvering of the vehicle along a travel route, and a vehicle operator (i.e., driver) provides inputs to the vehicle 400 to perform a portion of the navigation and/or maneuvering of the vehicle 400 along a travel route.

For example, Standard J3016 202104, Taxonomy and Definitions for Terms Related to Driving Automation Systems for On-Road Motor Vehicles, issued by the Society of Automotive Engineers (SAE) International on Jan. 16, 2014, and most recently revised on Apr. 30, 2021, defines six levels of driving automation. These six levels include: (1) level 0, no automation, in which all aspects of dynamic driving tasks are performed by a human driver; (2) level 1, driver assistance, in which a driver assistance system, if selected, can execute, using information about the driving environment, either steering or acceleration/deceleration tasks, but all remaining driving dynamic tasks are performed by a human driver; (3) level 2, partial automation, in which one or more driver assistance systems, if selected, can execute, using information about the driving environment, both steering and acceleration/deceleration tasks, but all remaining driving dynamic tasks are performed by a human driver; (4) level 3, conditional automation, in which an automated driving system, if selected, can execute all aspects of dynamic driving tasks with an expectation that a human driver will respond appropriately to a request to intervene; (5) level 4, high automation, in which an automated driving system, if selected, can execute all aspects of dynamic driving tasks even if a human driver does not respond appropriately to a request to intervene; and (6) level 5, full automation, in which an automated driving system can execute all aspects of dynamic driving tasks under all roadway and environmental conditions that can be managed by a human driver.

The vehicle 400 can include various elements. The vehicle 400 can have any combination of the various elements illustrated in FIG. 4. In various embodiments, it may not be necessary for the vehicle 400 to include all of the elements illustrated in FIG. 4. Furthermore, the vehicle 400 can have elements in addition to those illustrated in FIG. 4. While the various elements are illustrated in FIG. 4 as being located within the vehicle 400, one or more of these elements can be located external to the vehicle 400. Furthermore, the elements illustrated may be physically separated by large distances. For example, as described, one or more components of the disclosed system can be implemented within the vehicle 400 while other components of the system can be implemented within a cloud-computing environment, as described below. For example, the elements can include one or more processors 410, one or more data stores 415, a sensor system 420, an input system 430, an output system 435, vehicle systems 440, one or more actuators 450, one or more automated driving modules 460, and a communications system 470.

In one or more arrangements, the one or more processors 410 can be a main processor of the vehicle 400. For example, the one or more processors 410 can be an electronic control unit (ECU).

The one or more data stores 415 can store, for example, one or more types of data. The one or more data stores 415 can include volatile memory and/or non-volatile memory. Examples of suitable memory for the one or more data stores 415 can include Random-Access Memory (RAM), flash memory, Read-Only Memory (ROM), Programmable Read-Only Memory (PROM), Erasable Programmable Read-Only Memory (EPROM), Electrically Erasable Programmable Read-Only Memory (EEPROM), registers, magnetic disks, optical disks, hard drives, any other suitable storage medium, or any combination thereof. The one or more data stores 415 can be a component of the one or more processors 410. Additionally or alternatively, the one or more data stores 415 can be operatively connected to the one or more processors 410 for use thereby. As used herein, “operatively connected” can include direct or indirect connections, including connections without direct physical contact. As used herein, a statement that a component can be “configured to” perform an operation can be understood to mean that the component requires no structural alterations, but merely needs to be placed into an operational state (e.g., be provided with electrical power, have an underlying operating system running, etc.) in order to perform the operation.

In one or more arrangements, the one or more data stores 415 can store map data 416. The map data 416 can include maps of one or more geographic areas. In some instances, the map data 416 can include information or data on roads, traffic control devices, road markings, structures, features, and/or landmarks in the one or more geographic areas. The map data 416 can be in any suitable form. In some instances, the map data 416 can include aerial views of an area. In some instances, the map data 416 can include ground views of an area, including 360-degree ground views. The map data 416 can include measurements, dimensions, distances, and/or information for one or more items included in the map data 416 and/or relative to other items included in the map data 416. The map data 416 can include a digital map with information about road geometry. The map data 416 can be high quality and/or highly detailed.

In one or more arrangements, the map data 416 can include one or more terrain maps 417. The one or more terrain maps 417 can include information about the ground, terrain, roads, surfaces, and/or other features of one or more geographic areas. The one or more terrain maps 417 can include elevation data of the one or more geographic areas. The map data 416 can be high quality and/or highly detailed. The one or more terrain maps 417 can define one or more ground surfaces, which can include paved roads, unpaved roads, land, and other things that define a ground surface.

In one or more arrangements, the map data 416 can include one or more static obstacle maps 418. The one or more static obstacle maps 418 can include information about one or more static obstacles located within one or more geographic areas. A “static obstacle” can be a physical object whose position does not change (or does not substantially change) over a period of time and/or whose size does not change (or does not substantially change) over a period of time. Examples of static obstacles can include trees, buildings, curbs, fences, railings, medians, utility poles, statues, monuments, signs, benches, furniture, mailboxes, large rocks, and hills. The static obstacles can be objects that extend above ground level. The one or more static obstacles included in the one or more static obstacle maps 418 can have location data, size data, dimension data, material data, and/or other data associated with them. The one or more static obstacle maps 418 can include measurements, dimensions, distances, and/or information for one or more static obstacles. The one or more static obstacle maps 418 can be high quality and/or highly detailed. The one or more static obstacle maps 418 can be updated to reflect changes within a mapped area.

In one or more arrangements, the one or more data stores 415 can store sensor data 419. As used herein, “sensor data” can refer to any information about the sensors with which the vehicle 400 can be equipped including the capabilities of and other information about such sensors. The sensor data 419 can relate to one or more sensors of the sensor system 420. For example, in one or more arrangements, the sensor data 419 can include information about one or more lidar sensors 424 of the sensor system 420.

In some arrangements, at least a portion of the map data 416 and/or the sensor data 419 can be located in one or more data stores 415 that are located onboard the vehicle 400. Additionally or alternatively, at least a portion of the map data 416 and/or the sensor data 419 can be located in one or more data stores 415 that are located remotely from the vehicle 400.

The sensor system 420 can include one or more sensors. As used herein, a “sensor” can refer to any device, component, and/or system that can detect and/or sense something. The one or more sensors can be configured to detect and/or sense in real-time. As used herein, the term “real-time” can refer to a level of processing responsiveness that is perceived by a user or system to be sufficiently immediate for a particular process or determination to be made, or that enables the processor to keep pace with some external process.

In arrangements in which the sensor system 420 includes a plurality of sensors, the sensors can work independently from each other. Alternatively, two or more of the sensors can work in combination with each other. In such a case, the two or more sensors can form a sensor network. The sensor system 420 and/or the one or more sensors can be operatively connected to the one or more processors 410, the one or more data stores 415, and/or another element of the vehicle 400 (including any of the elements illustrated in FIG. 4). The sensor system 420 can acquire data of at least a portion of the external environment of the vehicle 400 (e.g., nearby vehicles). The sensor system 420 can include any suitable type of sensor. Various examples of different types of sensors are described herein. However, one of skill in the art understands that the embodiments are not limited to the particular sensors described herein.

The sensor system 420 can include one or more vehicle sensors 421. The one or more vehicle sensors 421 can detect, determine, and/or sense information about the vehicle 400 itself. In one or more arrangements, the one or more vehicle sensors 421 can be configured to detect and/or sense position and orientation changes of the vehicle 400 such as, for example, based on inertial acceleration. In one or more arrangements, the one or more vehicle sensors 421 can include one or more accelerometers, one or more gyroscopes, an inertial measurement unit (IMU), a dead-reckoning system, a global navigation satellite system (GNSS), a global positioning system (GPS), a navigation system 447, and/or other suitable sensors. The one or more vehicle sensors 421 can be configured to detect and/or sense one or more characteristics of the vehicle 400. In one or more arrangements, the one or more vehicle sensors 421 can include a speedometer to determine a current speed of the vehicle 400.

Additionally or alternatively, the sensor system 420 can include one or more environment sensors 422 configured to acquire and/or sense driving environment data. As used herein, “driving environment data” can include data or information about the external environment in which a vehicle is located or one or more portions thereof. For example, the one or more environment sensors 422 can be configured to detect, quantify, and/or sense obstacles in at least a portion of the external environment of the vehicle 400 and/or information/data about such obstacles. Such obstacles may be stationary objects and/or dynamic objects. The one or more environment sensors 422 can be configured to detect, measure, quantify, and/or sense other things in the external environment of the vehicle 400 such as, for example, lane markers, signs, traffic lights, traffic signs, lane lines, crosswalks, curbs proximate the vehicle 400, off-road objects, etc.

Various examples of sensors of the sensor system 420 are described herein. The example sensors may be part of the one or more vehicle sensors 421 and/or the one or more environment sensors 422. However, one of skill in the art understands that the embodiments are not limited to the particular sensors described.

In one or more arrangements, the one or more environment sensors 422 can include one or more radar sensors 423, one or more lidar sensors 424, one or more sonar sensors 425, and/or one more cameras 426. In one or more arrangements, the one or more cameras 426 can be one or more high dynamic range (HDR) cameras or one or more infrared (IR) cameras. For example, the one or more cameras 426 can be used to record a reality of a state of an item of information that can appear in the digital map.

The input system 430 can include any device, component, system, element, arrangement, or groups thereof that enable information/data to be entered into a machine. The input system 430 can receive an input from a vehicle passenger (e.g., a driver or a passenger). The output system 435 can include any device, component, system, element, arrangement, or groups thereof that enable information/data to be presented to a vehicle passenger (e.g., a driver or a passenger).

Various examples of the one or more vehicle systems 440 are illustrated in FIG. 4. However, one of skill in the art understands that the vehicle 400 can include more, fewer, or different vehicle systems. Although particular vehicle systems can be separately defined, each or any of the systems or portions thereof may be otherwise combined or segregated via hardware and/or software within the vehicle 400. For example, the one or more vehicle systems 440 can include a propulsion system 441, a braking system 442, a steering system 443, a throttle system 444, a transmission system 445, a signaling system 446, and/or the navigation system 447. Each of these systems can include one or more devices, components, and/or a combination thereof, now known or later developed.

The navigation system 447 can include one or more devices, applications, and/or combinations thereof, now known or later developed, configured to determine the geographic location of the vehicle 400 and/or to determine a travel route for the vehicle 400. The navigation system 447 can include one or more mapping applications to determine a travel route for the vehicle 400. The navigation system 447 can include a global positioning system, a local positioning system, a geolocation system, and/or a combination thereof.

The one or more actuators 450 can be any element or combination of elements operable to modify, adjust, and/or alter one or more of the vehicle systems 440 or components thereof responsive to receiving signals or other inputs from the one or more processors 410 and/or the one or more automated driving modules 460. Any suitable actuator can be used. For example, the one or more actuators 450 can include motors, pneumatic actuators, hydraulic pistons, relays, solenoids, and/or piezoelectric actuators.

The one or more processors 410 and/or the one or more automated driving modules 460 can be operatively connected to communicate with the various vehicle systems 440 and/or individual components thereof. For example, the one or more processors 410 and/or the one or more automated driving modules 460 can be in communication to send and/or receive information from the various vehicle systems 440 to control the movement, speed, maneuvering, heading, direction, etc. of the vehicle 400. The one or more processors 410 and/or the one or more automated driving modules 460 may control some or all of these vehicle systems 440 and, thus, may be partially or fully automated.

The one or more processors 410 and/or the one or more automated driving modules 460 may be operable to control the navigation and/or maneuvering of the vehicle 400 by controlling one or more of the vehicle systems 440 and/or components thereof. For example, when operating in an automated mode, the one or more processors 410 and/or the one or more automated driving modules 460 can control the direction and/or speed of the vehicle 400. The one or more processors 410 and/or the one or more automated driving modules 460 can cause the vehicle 400 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” can mean to make, force, compel, direct, command, instruct, and/or enable an event or action to occur or at least be in a state where such event or action may occur, either in a direct or indirect manner.

The communications system 470 can include one or more receivers 471 and/or one or more transmitters 472. The communications system 470 can receive and transmit one or more messages through one or more wireless communications channels. For example, the one or more wireless communications channels can be in accordance with the Institute of Electrical and Electronics Engineers (IEEE) 802.11p standard to add wireless access in vehicular environments (WAVE) (the basis for Dedicated Short-Range Communications (DSRC)), the 3rd Generation Partnership Project (3GPP) Long-Term Evolution (LTE) Vehicle-to-Everything (V2X) (LTE-V2X) standard (including the LTE Uu interface between a mobile communication device and an Evolved Node B of the Universal Mobile Telecommunications System), the 3GPP fifth generation (5G) New Radio (NR) Vehicle-to-Everything (V2X) standard (including the 5G NR Uu interface), or the like. For example, the communications system 470 can include “connected vehicle” technology. “Connected vehicle” technology can include, for example, devices to exchange communications between a vehicle and other devices in a packet-switched network. Such other devices can include, for example, another vehicle (e.g., “Vehicle to Vehicle” (V2V) technology), roadside infrastructure (e.g., “Vehicle to Infrastructure” (V21) technology), a cloud platform (e.g., “Vehicle to Cloud” (V2C) technology), a pedestrian (e.g., “Vehicle to Pedestrian” (V2P) technology), or a network (e.g., “Vehicle to Network” (V2N) technology. “Vehicle to Everything” (V2X) technology can integrate aspects of these individual communications technologies.

Moreover, the one or more processors 410, the one or more data stores 415, and the communications system 470 can be configured to one or more of form a micro cloud, participate as a member of a micro cloud, or perform a function of a leader of a micro cloud. A micro cloud can be characterized by a distribution, among members of the micro cloud, of one or more of one or more computing resources or one or more data storage resources in order to collaborate on executing operations. The members can include at least connected vehicles.

The vehicle 400 can include one or more modules, at least some of which are described herein. The modules can be implemented as computer-readable program code that, when executed by the one or more processors 410, implement one or more of the various processes described herein. One or more of the modules can be a component of the one or more processors 410. Additionally or alternatively, one or more of the modules can be executed on and/or distributed among other processing systems to which the one or more processors 410 can be operatively connected. The modules can include instructions (e.g., program logic) executable by the one or more processors 410. Additionally or alternatively, the one or more data store 415 may contain such instructions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

The vehicle 400 can include one or more automated driving modules 460. The one or more automated driving modules 460 can be configured to receive data from the sensor system 420 and/or any other type of system capable of capturing information relating to the vehicle 400 and/or the external environment of the vehicle 400. In one or more arrangements, the one or more automated driving modules 460 can use such data to generate one or more driving scene models. The one or more automated driving modules 460 can determine position and velocity of the vehicle 400. The one or more automated driving modules 460 can determine the location of obstacles, obstacles, or other environmental features including traffic signs, trees, shrubs, neighboring vehicles, pedestrians, etc.

The one or more automated driving modules 460 can be configured to receive and/or determine location information for obstacles within the external environment of the vehicle 400 for use by the one or more processors 410 and/or one or more of the modules described herein to estimate position and orientation of the vehicle 400, vehicle position in global coordinates based on signals from a plurality of satellites, or any other data and/or signals that could be used to determine the current state of the vehicle 400 or determine the position of the vehicle 400 with respect to its environment for use in either creating a map or determining the position of the vehicle 400 in respect to map data.

The one or more automated driving modules 460 can be configured to determine one or more travel paths, current automated driving maneuvers for the vehicle 400, future automated driving maneuvers and/or modifications to current automated driving maneuvers based on data acquired by the sensor system 420, driving scene models, and/or data from any other suitable source such as determinations from the sensor data 419. As used herein, “driving maneuver” can refer to one or more actions that affect the movement of a vehicle. Examples of driving maneuvers include: accelerating, decelerating, braking, turning, moving in a lateral direction of the vehicle 400, changing travel lanes, merging into a travel lane, and/or reversing, just to name a few possibilities. The one or more automated driving modules 460 can be configured to implement determined driving maneuvers. The one or more automated driving modules 460 can cause, directly or indirectly, such automated driving maneuvers to be implemented. As used herein, “cause” or “causing” means to make, command, instruct, and/or enable an event or action to occur or at least be in a state where such event or action may occur, either in a direct or indirect manner. The one or more automated driving modules 460 can be configured to execute various vehicle functions and/or to transmit data to, receive data from, interact with, and/or control the vehicle 400 or one or more systems thereof (e.g., one or more of vehicle systems 440). For example, functions and/or operations of an automotive navigation system can be realized by the one or more automated driving modules 460.

Detailed embodiments are disclosed herein. However, one of skill in the art understands, in light of the description herein, that the disclosed embodiments are intended only as examples. Therefore, specific structural and functional details disclosed herein are not to be interpreted as limiting, but merely as a basis for the claims and as a representative basis for teaching one of skill in the art to variously employ the aspects herein in virtually any appropriately detailed structure. Furthermore, the terms and phrases used herein are not intended to be limiting but rather to provide an understandable description of possible implementations. Various embodiments are illustrated in FIGS. 1-4, but the embodiments are not limited to the illustrated structure or application.

The flowchart and block diagrams in the figures illustrate the architecture, functionality, and operation of possible implementations of systems, methods, and computer program products according to various embodiments. In this regard, each block in flowcharts or block diagrams may represent a module, segment, or portion of code, which comprises one or more executable instructions for implementing the specified logical function(s). One of skill in the art understands, in light of the description herein, that, in some alternative implementations, the functions described in a block may occur out of the order depicted by the figures. For example, two blocks depicted in succession may, in fact, be executed substantially concurrently, or the blocks may be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suitable. A typical combination of hardware and software can be a processing system with computer-readable program code that, when loaded and executed, controls the processing system such that it carries out the methods described herein. The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product that comprises all the features enabling the implementation of the methods described herein and that, when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. As used herein, the phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples of the computer-readable storage medium would include, in a non-exhaustive list, the following: a portable computer diskette, a hard disk drive (HDD), a solid-state drive (SSD), a read-only memory (ROM), an erasable programmable read-only memory (EPROM or flash memory), a portable compact disc read-only memory (CD-ROM), a digital versatile disc (DVD), an optical storage device, a magnetic storage device, or any suitable combination of the foregoing. As used herein, a computer-readable storage medium may be any tangible medium that can contain or store a program for use by or in connection with an instruction execution system, apparatus, or device.

Generally, modules, as used herein, include routines, programs, objects, components, data structures, and so on that perform particular tasks or implement particular data types. In further aspects, a memory generally stores such modules. The memory associated with a module may be a buffer or may be cache embedded within a processor, a random-access memory (RAM), a ROM, a flash memory, or another suitable electronic storage medium. In still further aspects, a module as used herein, may be implemented as an application-specific integrated circuit (ASIC), a hardware component of a system on a chip (SoC), a programmable logic array (PLA), or another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the disclosed technologies may be written in any combination of one or more programming languages, including an object-oriented programming language such as Java™, Smalltalk, C++, or the like, and conventional procedural programming languages such as the “C” programming language or similar programming languages. The program code may execute entirely on a user's computer, partly on a user's computer, as a stand-alone software package, partly on a user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . or . . . ” as used herein refers to and encompasses any and all possible combinations of one or more of the associated listed items. For example, the phrase “at least one of A, B, or C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope thereof.

What is claimed is:

1. A system, comprising:
a processor; and
a memory storing:
a set determination module including instructions that, when executed by the processor, cause the processor to determine, from:
positions of a vehicle that traversed a region, and
data affiliated with images produced by a camera on the vehicle,
a set of information to be used to produce a map of the region, an optimal state of the set being based on at least one of:
a characteristic of the information, or
an aspect, in the region, to be included in the map;
a production module including instructions that, when executed by the processor, cause the processor to produce, from the set, the map; and
a communications module including instructions that, when executed by the processor, cause the processor to transmit the map to a specific vehicle to control movement of the specific vehicle.

2. The system of claim 1, wherein:
the aspect, in the region, includes a portion of a road,
the data affiliated with the images include information about positions of points for a road boundary of the portion of the road, and
the road boundary is represented as an object in an image in the images.

3. The system of claim 2, wherein the instructions to determine the set of information include instructions to determine, based on the positions of the vehicle and the positions of the points for the road boundary, at least one position of at least one lane of the road.

4. The method of claim 3, wherein the instructions to determine the position of the at least one lane of the road include instructions to determine, based on the positions of the vehicle, the positions of the points for the road boundary, and at least one position of a center of the road, the at least one position of the at least one lane of the road.

5. The system of claim 3, wherein:
the road boundary comprises a first road boundary and a second road boundary,
the portion of the road is located between the first road boundary and the second road boundary, and
the instructions to determine the at least one position of the at least one lane of the road include instructions to determine, based on the positions of the vehicle, the positions of the points for the first road boundary, and the positions of the points for the second road boundary, the at least one position of the at least one lane of the road.

6. The system of claim 3, wherein the instructions to determine the at least one position of the at least one lane of the road include:
instructions to determine, based on the positions of the vehicle and the positions of the points for the road boundary, an existence of a curve in the portion of the road;
instructions to cause a repositioning of the positions of the vehicle and the positions of the points for the road boundary so that after the repositioning:
the curve is coincidental with a line, and
a relative position, between a position of one point, of at least one of the positions of the vehicle or the positions of the points for the road boundary, and a position of another point, of the at least one of the positions of the vehicle or the positions of the points for the road boundary, is a same as the relative position before the repositioning; and
instructions to determine, after the repositioning, the at least one position of the at least one lane of the road.

7. The system of claim 3, wherein the vehicle that traversed the region is associated with a plurality of traversals, the plurality of traversals being associated with at least one of:
a vehicle that traversed, on a plurality of occasions, the region, or
a plurality of vehicles that traversed, on the plurality of occasions, the region, the camera on the vehicle being a plurality of cameras on the plurality of vehicles.

8. The system of claim 7, wherein:
the positions of each of the plurality of traversals have a length within the region,
a set of the positions of the each of the plurality of traversals comprises the positions of the each of the plurality of traversals in which the length within the region is greater than a threshold length, and
the optimal state of the set of the information comprises a count of elements in the set of the positions of the each of the plurality of traversals being greater than a threshold count.

9. The system of claim 7, wherein:
the positions of each of the plurality of traversals comprise positions of points in a sequence of points,
a set of the positions of the each of the plurality of traversals comprises the positions of the each of the plurality of traversals in which an average distance between a position of a point in the sequence and a position of an immediately subsequent point in the sequence is less than a threshold distance, and
the optimal state of the set of the information comprises a count of elements in the set of the positions of the each of the plurality of traversals being greater than a threshold count.

10. The system of claim 7, wherein:
the plurality of occasions comprises a first set of the plurality of occasions and a second set of the plurality of occasions,
the at least one lane comprises a first lane and a second lane,
the first set of the plurality of occasions is affiliated with traversals of the first lane, and
the second set of the plurality of occasions is affiliated with traversals of the second lane.

11. The system of claim 10, wherein:
the instructions to determine the at least one position of the at least one lane of the road include instructions to determine a position of the road boundary, and
the instructions to determine the position of the road boundary include instructions to interpolate among:
the positions of the points for the road boundary affiliated with the traversals of the first lane, and
the positions of the points for the road boundary affiliated with the traversals of the second lane.

12. The system of claim 11, wherein:
the instructions to determine the at least one position of the at least one lane of the road further include instructions to determine a position of a lane boundary of the at least one lane, and
the instructions to determine the position of the lane boundary include instructions to interpolate among:
the positions of the points for the lane boundary affiliated with the traversals of the first lane, and
the positions of the points for the lane boundary affiliated with the traversals of the second lane.

13. The system of claim 10, wherein the optimal state of the set of the information comprises:
a count of the positions of the plurality of traversals affiliated with the traversals of the first lane
being substantially equal to
a count of the positions of the plurality of traversals affiliated with the traversals of the second lane.

14. The system of claim 10, wherein the optimal state of the set of the information comprises a count of each of:
the positions of the plurality of traversals affiliated with the traversals of the first lane, and
the positions of the plurality of traversals affiliated with the traversals of the second lane
being greater than a first threshold, but less than a second threshold.

15. The system of claim 10, wherein:
the aspect, in the region, further includes a landmark,
the data affiliated with the images further include information about positions of points for the landmark,
the landmark is represented as another object in the image,
the plurality of traversals comprises a first set of the plurality of traversals and a second set of the plurality of traversals,
the data affiliated with the images affiliated with the first set of the plurality of traversals include the information about the positions of the points for the landmark,
the data affiliated with the images affiliated with the second set of the plurality of traversals lack the information about the positions of the points for the landmark, and
the optimal state of the set of the information comprises information affiliated with at least one traversal of the first set of the plurality of traversals.

16. The system of claim 15, wherein:
the first lane is nearer to the landmark than the second lane, and
the at least one traversal of the first set of the plurality of traversals comprises at least one traversal of the first set of the plurality of occasions.

17. A method, comprising:
determining, by a processor and from:
positions of a vehicle that traversed a region, and
data affiliated with images produced by a camera on the vehicle,
a set of information to be used to produce a map of the region, an optimal state of the set being based on at least one of:
a characteristic of the information, or
an aspect, in the region, to be included in the map;
producing, by the processor and from set, the map; and
transmitting, by the processor, the map to a specific vehicle to control movement of the specific vehicle.

18. The method of claim 17, wherein the positions of the vehicle are included in a geographic position trace of the vehicle.

19. The method of claim 17, wherein the data affiliated with the images exclude pixel color data.

20. A non-transitory computer-readable medium for determining a set of information to be used to produce a map of a region, the non-transitory computer-readable medium including instructions that, when executed by one or more processors, cause the one or more processors to:
determine from:
positions of a vehicle that traversed a region, and
data affiliated with images produced by a camera on the vehicle,
a set of information to be used to produce a map of the region, an optimal state of the set being based on at least one of:
a characteristic of the information, or
an aspect, in the region, to be included in the map;
produce, from set, the map; and
transmit the map to a specific vehicle to control movement of the specific vehicle.
